(19) United States
(12) Patent Application Publication
(10) Pub. No.: US 2006/0217835 A1
(43) Pub. Date: Sep. 28, 2006

(54) Storage container

(75) Inventor: Anatoli Stobbe, Barsinghausen (DE)

Correspondence Address: WILLIAM COLLARD;COLLARD & ROE, P.C., 1077 NORTHERN BOULEVARD, ROSLYN, NY, 11576, US

(73) Assignee: ASTRA Gesellschaft fur Asset Management mbH & Co., KG

(21) Appl. No.: 11/389,200

(22) Filed: Mar. 24, 2006

(30) Foreign Application Priority Data
Mar. 24, 2005 (DE) 10 2005 014 343.1

(51) Int. Cl. G06F 7/00

(52) U.S. Cl. 700/214

(57) ABSTRACT

A storage container which can include a housing with lockable and unlockabe drawers and engagement mechanisms in the drawers for identification carriers with objects that are to be safeguarded. The storage container can further include a device for reading data stored in the identification carriers and an evaluation and control unit and a display device. The reading device includes transmission means that are arranged fixedly in the housing and associated to the drawers for contactless transmission of data between the identification carriers and the reading device. When the drawers are closed, the engaging mechanisms are positioned in the detection range of the associated transmission means.

### CROSS REFERENCE TO RELATED APPLICATIONS

Applicants claim priority under 35 U.S.C. §119 of German Application No. 10 2005 014 343.1 filed on Mar. 24, 2005.

### BACKGROUND OF THE INVENTION

The invention relates to a storage container for receiving particular identification carriers.

In a storage container defining the species and known from German Patent No. DE 100 42 150 A1, a reading unit and a memory unit are assigned to each drawer. The reading unit is designed to accommodate an identification carrier and is located inside the drawer, whereas the memory unit is located on the back of the drawer. The reading unit and the memory unit are connected to a central controller.

The document cited does not disclose any details regarding the nature of the connection between the identification carrier and the reading unit, but the constructed embodiment uses a galvanic connection via contacts. Moreover, since the reading units and the memory units are disposed in or on the drawer, but the central controller is attached in fixed manner on the housing, the reading units and the memory units are connected to the central controller via trailing cables, which are able to follow the sliding motion of the drawers.

### SUMMARY OF INVENTION

An object of the invention is to avoid malfunctions due to contact errors and broken wires in a species-defining storage container.

Since the drawers are the parts that are most prone to wear, one solution according to the invention can deal with the purely mechanical components in the design thereof. The electrical or electronic components are disposed in a fixed manner in or on the housing, and are therefore not subject to any mechanical wear due to the coupling of the identification carriers with the reading device or bending loads on the supply lines due to repeated opening and closing of the drawers.

In particular, errors caused by faulty contacts are prevented by transmission means for contactless data transmission, and in the case of trailing cables, wire breaks are prevented by the stationary location of the transmission means in the housing. In addition, the length of cable required is shorter, so that storage space for accommodating the cables is no longer required, and the wiring that is present is less susceptible to crosstalk and radiated interference. Manufacture and installation are also simplified, since the electrical and electronic components as well as the cables are able to be fully installed on one level in advance, and a connection to the drawers is not required. The drawers and their engagement mechanisms may be installed entirely separately, and if necessary, worn engagement mechanisms may be replaced, or they may be replaced or supplemented easily by engagement mechanisms with a different design so that they may be adapted to differently shaped information carriers.

The transmission means may include coils for inductive transmission of data and/or energy.

This design enables the use of identification carriers in transponder technology with inductive or electromagnetic transmission in the NF, LF or HF ranges, i.e. between 8 kHz and 15 MHz. The identification carriers are able to have their own energy source, or they may receive their energy from the reading device by inductive or electromagnetic transmission in the NF, LF or HF ranges. Inductive or electromagnetic transmission of energy and data is also possible via another transmission medium, for example an optical or acoustic medium.

The transmission means may also include diodes for optical data transmission.

This type of data transmission is particularly resistant to radiated interference besides being intercept-proof.

The engagement mechanisms may have replaceable retaining elements, which are adapted to the shape of the identification carriers.

In this way, existing identification carriers made by other manufacturers may also be securely retained and centred, so that they remain optimally coupled with the stationary transmission means when the drawers are in the inserted position.

According to one refinement, the engagement mechanisms include clamping or latching fixtures for securing the identification carriers.

In this way, it is ensured that the identification carriers are securely anchored in the engagement mechanisms and do not slip out and are then unable to be coupled securely to the transmission means if the drawers are pushed or pulled sharply.

The housing may include locking mechanisms assigned to the drawers, which lock the drawers automatically when the drawers are pushed in, and piezoelectric, magneto electric or electromotive actuators may be activated by the evaluation and control unit to unlock the drawers.

In the case of an open, empty drawer, an identification carrier may be returned and the drawer may be locked at any time after it is closed, without authentication. However, it may be arranged so that removing anything from the drawer requires prior authentication.

The actuators may be blocked by spring biasing of the drawers and the block may be removed by pressing the drawers in.

This prevents drawers that have been released from opening spontaneously, since a prior manual action is required. Thus, for example the drawers may be locked again by a timed lock if they are not opened by a manual operation within a certain period of time.

According to one refinement, the display device may include optical signal transmitters arranged in fixed manner in the housing and assigned to the drawers, wherein the optical signal transmitters are coupled to display panels disposed on front panels of the drawers via optical fibres in the drawers when the drawers are closed.

In this way, statuses may be displayed on the front panels of the drawers without the need to attach electrical wires to the drawers themselves.

Additionally, the reading device may also include a writing device for writing data contained in the identification carriers.

In this way, data from the information carriers may be modified while the drawers are locked without the need to provide an additional writing unit for the same storage container. Security against possible tampering is thus increased.

The identification carriers may include housings with identification chips in which an identification number is stored, and transmission means, such as objects being attached to the identification carrier housing via hard-wired connecting elements.

In this way, it is possible to assign an identification number to all types of individual objects or combinations of objects via connected identification carriers.

The identification carriers may also include housings with identification chips in which an identification number is stored, and include transmission means, and may themselves be the objects.

In this case, the objects may be identified and managed without the need for an additional identification carrier. Instead, the information that is stored anyway for other purposes is used and read to this end.

The identification carriers may be electronic car keys, the key number of which is able to be evaluated as the identification number by the reading device.

It is very important to keep car keys safe in motor pools, freight companies, car rental agencies and vehicle sales offices, to prevent misuse and loss of insurance cover. The evaluation of key numbers as the identification number enables assignment to be made directly instead of indirectly via a separate identification carrier.

In addition, insertion switches may be arranged in the housing to verify the presence of identification carriers or objects inserted in the engagement mechanisms, and the insertion switches may be connected to the evaluation and control device.

The physical presence of identification carriers or objects inserted in the engagement mechanisms may be confirmed via the insertion switches. In this way, it is possible to detect errors caused by identification carriers and objects that are not inserted fully and are therefore not readable. Identification carriers or objects that have been fully inserted, but which are defective or unreadable or do not belong to the system, may also be detected.

The identification carriers may also be electronic car keys, the identification chips of which store vehicle data such as vehicle identification number, kilometres travelled, service data, error data, maximum speed, operating range, which may be evaluated by the reading device.

By evaluating this vehicle data, it is possible to evaluate safety or service-related vehicle data with the same storage container and in the same reading and evaluation operation but without an additional reading device.

Variable vehicle data stored in the identification chip, such as maximum speed, operating range, may also be writable via the writing device in conjunction with a navigation device.

In this way, safety-related vehicle data may be modified with the same storage container without an additional writing device.

According to a refinement of the invention, additional compartments with fixed engagement mechanisms for identification carriers are arranged in the housing and are connected via non-detachable connecting elements with objects that are to be stored securely.

This configuration enables the housing as well as the electrical and electronic components of the storage container to be used for larger objects as well, such as measurement devices, computers, and files, which do not fit in the drawers.

### BRIEF DESCRIPTION OF THE DRAWINGS

Other benefits and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a storage container,

FIG. 2 shows a lengthwise section through a drawer in the housing of the storage container,

FIG. 3 shows a cross section through a drawer in the housing of the storage container and

FIG. 4 shows an engagement mechanism for a car key.

### DETAILED DESCRIPTION

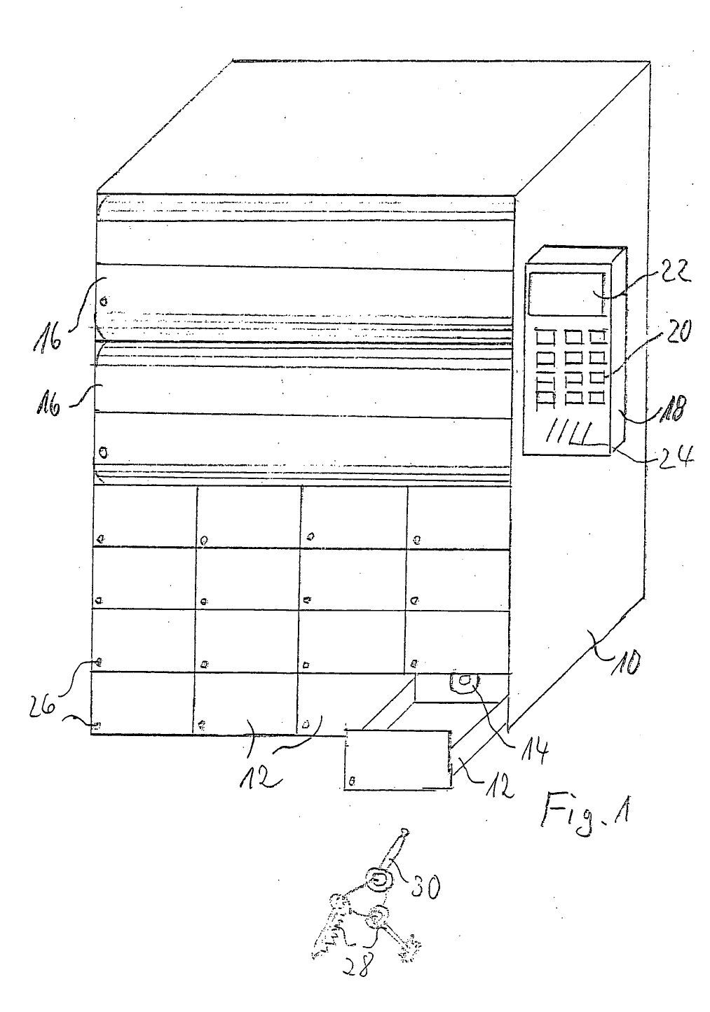

FIG. 1 is a representation of a storage container. This includes a housing 10 with drawers 12 and engagement mechanisms 14 as well as additional storage compartments 16. Transmission equipment, reading devices and a multiplexer are also disposed in housing 10, but are not shown in FIG. 1. An operating console 18 connected to the multiplexer is arranged on the side of housing 10. Operating console 18 includes an evaluation and control device, a keypad 20, a display unit 22 and a reading device 24. Additional display units in the form of view boxes 26 are arranged on front panels of drawers 12 and optionally on storage compartments 16. The storage container is used for the safe keeping of objects 28 with identification carriers 30.

To gain access to a stored identification carrier or object with an identification carrier, a user must prove that he is authorised to do so. This may be done by entering an authorisation number via keypad 20 on operating console 18, via an authorisation card that is read by a reading device 24 in operating console 18, or a combination of both methods. When access has been granted, one or more associated drawers 12 are unlocked or storage compartments 16 are unlocked or opened. The positions may be displayed on display unit 22 of operating console 18, or directly on view boxes 26 on front panels of drawers 12 or storage compartments 16. Unlocked drawers 12 may be opened after they are pressed in briefly to release the block established by an actuator.

The objects may then be taken out by removing identification carriers 30 from engagement mechanisms 14, and drawers 12 or storage compartments 16 may be closed. The procedure for unlocking or opening drawers 12 or storage compartments 16 to return the objects is the same as for taking the objects out. However, a simplified return function may also be configured to simplify returning the objects, according to which the identification number 30 itself needs only be coupled with the reading unit 24 on operating console 18 so that the identification number may be read and evaluated. In this case, the associated drawers 12 may be unlocked or the associated storage compartments 16 may be unlocked or opened automatically after the identification number has been evaluated, so that the need to enter an authorisation number via keypad 20 on operating console 18 or to have the data on an authorisation card read may also be dispensed with.

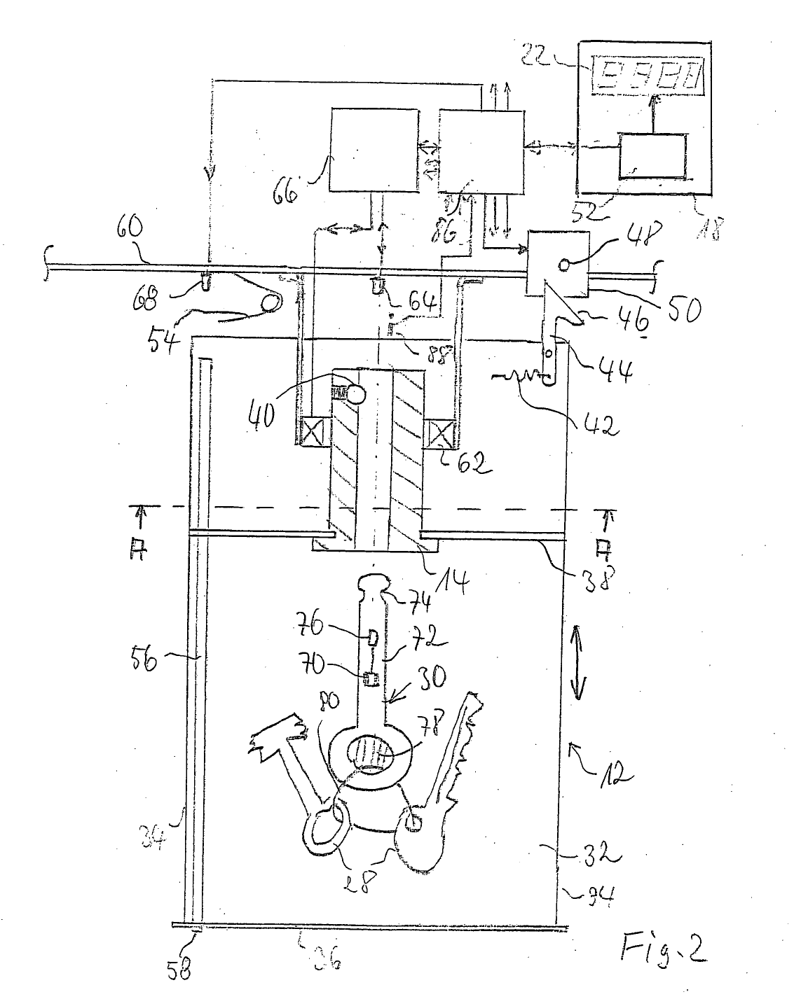

FIG. 2 shows a longitudinal section and FIG. 3 shows a cross section along line A-A in FIG. 2 through drawer 12 in the housing of the storage container. Drawer 12 includes a base panel 32, two side panels 34, a front panel 36 and a partition wall 38 arranged in front of the rear end of base panel 32. An engagement mechanism 14 for an identification carrier 30 is arranged in partition wall 38, and continues behind the partition wall. Engagement mechanism 14 includes a clamping or latching mechanism 40 for securing identification carriers 30.

In addition, a locking device in the form of a pivoting and spring-loaded ratchet 44 is arranged on base panel 32. When drawer 12 is pushed in, ratchet 44 is initially released from an actuator pin 48 over a bevel 46 and then clasps behind it due to the spring loading. Actuator pin 48 is a component of electromagnetic actuator 50, which is arranged inside the housing and may be activated to unlock drawer 12 by an evaluation and control device 52. A spring 54, disposed in the housing, presses against drawer 12 from behind and blocks actuator pin 48 via friction locking. When actuator 50 is activated, the pin is not able to be disengaged until the friction lock is cancelled by pressing in drawer 12.

An optical fibre 56 is also located in drawer 12, and passes from the rear of the drawer to a view box 58 on front panel 36.

A fixed mounting plate 60 in the housing supports a coil 62 serving as transmission means for inductive data and energy transmission and a diode 64 as transmission means for optical data transmission between a reading unit 66 in the storage container's housing and an identification carrier 30, as well as an optical signal transmitter 68 and an insertion switch 88 for mechanical registration of the insertion of an identification carrier. Additional transmission means, signal transmitters and insertion switches on mounting plate 60 are assigned to other drawers and storage compartments and are arranged in the manner of a matrix reflecting the position of these drawers and storage compartments.

The distance between transmission means 62, 64 and mounting plate 60 and the position of partition wall 38 in drawer 12 as well as the conformation of engagement mechanism 14 in conjunction with transmission means 70 of identification carrier 30 are adjusted with respect to each other in so that, when drawer 12 is closed, transmission means 70 from the identification carriers 30 that are fixed in engagement mechanism 14 of drawer 12 are located in the detection range of assigned transmission means 62, 64 of reading device 66. This arrangement assures optimum coupling.

Also, when drawer 12 is closed, optical signal transmitter 68 is coupled with optical fibre 56 in drawer 12, so that statuses displayed by signal transmitter 56 are visible in view box 58 on front panel 36. At the same time, insertion switch 88 is also activated when an identification carrier is present in engagement mechanism 14, so that identification carriers that are present but not readable may be detected.

Reading devices 66, which may also include writing devices for writing to identification chips, are connected via a multiplexer 86 to an evaluation and control unit 52 that is arranged in operating console 18 (see FIG. 1). This evaluates identification information and other data that is read and queries the statuses of insertion switches 88 via multiplexer 86. Evaluation and control unit 52 also controls a display unit 22, as well as actuators 50 via multiplexer 86. Display unit 22 is able to display data that has been read, entered via a keypad on an operating console, information about a user and his authorisations, as well as the positions of drawers 12 and storage compartments 16. To facilitate the assignment, evaluation and control unit 52 is also able to address optical signal transmitters 68 via multiplexer 86.

Thus, drawer 12 itself does not include any electrical or electronic components, it merely serves as a securely lockable means for storing identification carriers 30 and objects 28. The drawer can also be for precisely positioning identification carriers 30 in the detection range of the associated transmission means 62, 64 of reading device 66. This device design can be for optical forwarding of the display from optical signal transmitter 68 to front panel 36 when drawer 12 is closed. The transmission of data and possibly also energy between reading device 66 and identification carrier 30 as well as the optical forwarding of the display from optical signal transmitter 68 to front panel 36 are in a contactless manner and are thus immune to failure due to contact errors or wire breakages.

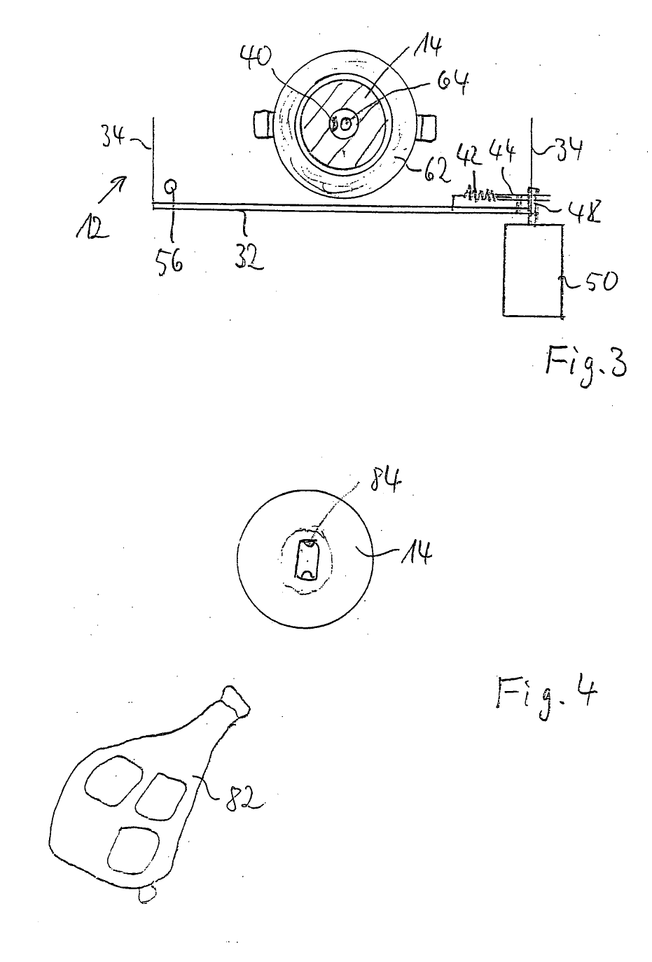

If the storage container is to be used to safeguard normal keys or valuables such as passports, credit cards, cameras or mobile phones, standard identification carriers may be used consisting of an insertion pin 72 with an engaging groove 74 and an installed identification chip 76 in conjunction with transmission means 70 and a key ring 80 that is protected by a seal 78, wherein the keys or valuables are connected in non-detachable manner to insertion pin 72 via key ring 80. Since car keys for modern vehicles are often identification carriers with an installed identification chip and transmission means in themselves, it is expedient to use the car key itself as the information carrier instead of an additional, standard information carrier. Exchangeable engagement mechanisms are provided for this purpose, and they have been adapted to the shapes of car keys made by various vehicle manufacturers. FIG. 4 shows an example of an engagement mechanism 14 for a car key 82.

Engagement mechanisms 14 have clamping devices 84 for securely retaining car key 82, so that they are able to be inserted and automatically secured in the corresponding engagement mechanism 14 in similar manner to an ignition lock in the vehicle. Engagement mechanisms 14 are also designed in so that when drawer 12 is closed the transmission means in the car key are also positioned in the detecting range of the assigned transmission means 62, 64 of reading device 66.

Accordingly, while at least one embodiment of the present invention have been shown and described, it is obvious that many changes and modifications may be made thereunto without departing from the spirit and scope of the invention.

What is claimed is:

1. A storage container for receiving particular identification carriers comprising:
a) a housing;
b) a plurality of drawers disposed in said housing that are lockable and unlockable;
c) a plurality of engagement mechanisms coupled to said plurality of said drawers for receiving the particular identification carriers;
d) at least one reading device for reading data stored in each identification carrier;
e) an evaluation and control unit; and
f) at least one display device
wherein said at least one reading device comprises a transmission means arranged fixedly on said housing and assigned to at least one of said plurality of drawers for contactless transmission of data and energy between the identification carriers and said at least one reading device, wherein plurality of said engagement mechanisms are positioned in a detection range of said assigned transmission means when said plurality of drawers are closed.

2. The storage container according to claim 1, wherein said transmission means include coils for inductive transmission of data.

3. The storage container according to claim 1, wherein said transmission means includes diodes for optical data transmission.

4. The storage container according to claim 1, wherein said plurality of engagement mechanisms have replaceable retaining elements, which are adapted to the shape of the identification carriers.

5. The storage container according to claim 1, wherein said plurality of engagement mechanisms include clamping or latching fixtures for securing the identification carriers.

6. The storage container according to claim 1, further comprising a plurality of locking mechanisms assigned to said plurality of drawers, and which lock said plurality of drawers automatically when said plurality of drawers are pushed in, the device further comprising a plurality of actuators which are activated by at least one of said evaluation and control unit to unlock said drawers.

7. The storage container according to claim 6, further comprising springs wherein said plurality of actuators are blocked by said springs tensioning said plurality of drawers and wherein said tension may be removed by pressing said drawers in.

8. The storage container according claim 1, wherein said display device includes a plurality of optical signal transmitters that are arranged in a fixed manner in said housing and assigned to said plurality of drawers, and wherein when plurality of drawers are closed, said optical signal transmitters are coupled to view boxes disposed on front panels of said drawers via optical fibres in said plurality of drawers.

9. The storage container according to claim 1, wherein said at least one reading device also includes at least one writing device for writing data contained in the identification carriers.

10. The storage container according to claim 1, wherein the identification carriers include housings with identification chips in which an identification number is stored, and each identification carrier further comprises a transmission means, and wherein additional objects are connected to the housings of each identification carrier via hard-wired connecting elements.

11. The storage container according to claim 10, wherein said additional objects are in the form of identification carriers include housings with identification chips in which an identification number is stored, and include transmission means.

12. The storage container according to claim 11, wherein the identification carriers are electronic car keys, a key number of which is able to be evaluated as an identification number by said at least one reading device.

13. The storage container according to claim 1, further comprising a plurality of insertion switches which are also arranged in said housing to verify the presence of the identification carriers or objects inserted in the engagement mechanisms, and wherein said plurality of insertion switches are connected to said evaluation and control device.

14. The storage container according to claim 11, wherein the identification carriers are electronic car keys, wherein said identification chips of which store vehicle data such as vehicle identification number, kilometres travelled, service data, error data, maximum speed, operating range, can be evaluated by the reading device.

15. The storage container according to claim 14, wherein variable vehicle data stored in the identification chip, such as maximum speed, operating range, is writable via the writing device in conjunction with a navigation device.

16. The storage container according to claim 1, wherein said housing further comprises additional compartments with fixed engagement mechanisms for the identification carriers and wherein said additional compartments are connected via non-detachable connecting elements with objects that are to be stored securely.

17. The storage container as in claim 6, wherein said plurality of actuators comprise at least one piezoelectric actuator.

18. The storage container as in claim 6, wherein said plurality of actuators comprise at least one magnetic electric actuator.

19. The storage container as in claim 6, wherein said plurality of actuators comprise at least one electromotive actuator.
